(19) United States
(12) Patent Application Publication
(10) Pub. No.: US 2018/0229330 A1
(43) Pub. Date: Aug. 16, 2018

(54) HYBRID STEERING WHEEL ARMATURE

(71) Applicant: Ford Global Technologies, LLC, Dearborn, MI (US)

(72) Inventors: Ishak ZAMAN, Novi, MI (US); James Robert CHASCSA, II, Farmington Hills, MI (US)

(21) Appl. No.: 15/429,643

(22) Filed: Feb. 10, 2017

(51) Int. Cl. B23K 20/12; B62D 1/04

(52) U.S. Cl. CPC B23K 20/129; B23K 20/122; B23K 20/1205; B62D 1/04

(57) ABSTRACT

A steering wheel armature includes a hub, a spoke and a rim. The hub has a first portion and a second portion. The second portion is attached to a steering column. The spoke is attached to the first portion of the hub via friction welding. The rim is friction welded to the spoke to interconnect the rim and the first portion of the hub, wherein the first portion is stir friction welded to the second portion such that the rim is attached to the steering column.

### TECHNICAL FIELD

This disclosure relates to a method of joining steering wheel components and specifically to joining a hub, rim and spokes to form an armature.

### BACKGROUND

Vehicles use steering wheels and steering columns to direct and steer the vehicle. The steering wheel connects to the steering column at an armature. The armature is the steering wheel's main load bearing component. Typically, the armature is composed of a cast metal. At the center of the armature is the hub, which is used to interconnect the steering wheel with the steering column using a fastener. Spokes are used to interconnect the hub and a rim to define the steering wheel. Each steering wheel may use a different number of spokes, or different rims with differing diameters based on the make and model of the vehicle. A different hub is typically used for each different style of steering wheel to balance noise, vibration and harshness transmitted through the steering column and steering wheel.

### SUMMARY

A steering wheel armature includes a hub, a spoke and a rim. The hub has a first portion and a second portion. The second portion is attached to a steering column. The spoke is attached to the first portion of the hub via friction welding. The rim is friction welded to the spoke to interconnect the rim and the first portion of the hub, wherein the first portion is stir friction welded to the second portion such that the rim is attached to the steering column.

A vehicle includes a steering column and a steering wheel armature. The steering wheel armature includes a hub having first and second portions. The second portion is attached via a fastener to the steering column. The armature also includes a spoke that is friction welded to the first portion of the hub. The steering wheel armature further includes a rim friction welded to the spoke interconnecting the rim with the first portion of the hub. The first portion of the hub is spin friction welded to the second portion to connect the steering wheel armature to the steering column.

A method for interconnecting a steering wheel armature to a steering column includes linear friction welding at least one spoke to a rim. The method also includes spin friction welding the at least one spoke, including the rim, to a first portion of a hub. The method further includes stir friction welding the first portion of the hub to a second portion of the hub. Lastly, the method includes fastening the second portion of the hub to the steering column.

### BRIEF DESCRIPTION OF THE DRAWINGS

FIG. 1 is a perspective view of a vehicle having a steering wheel and column;

FIG. 2 is a perspective view of a steering wheel and column;

FIG. 3 is a front view of a steering wheel; and

FIG. 4 is flow chart depicting steps for interconnecting a steering wheel armature to a steering column.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

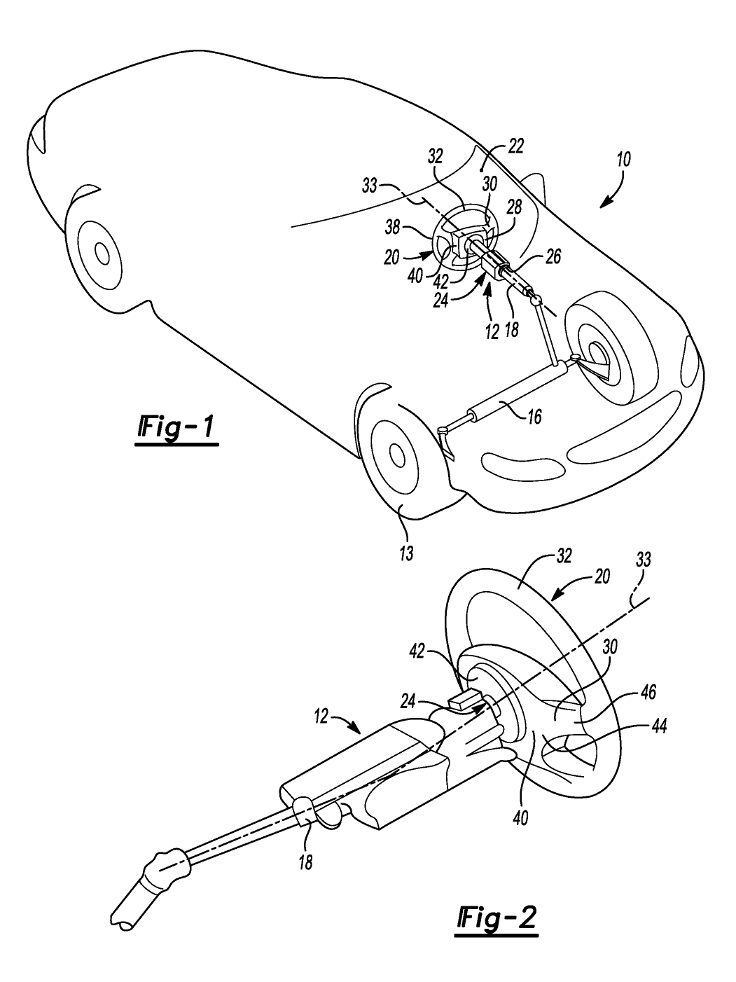

FIG. 1 depicts a perspective view of a vehicle 10. The vehicle 10 includes a steering system 12. Steering system 12 may be used to steer and direct the vehicle 10. The steering system 12 includes a set of wheels 13, an axle 16 and a steering column 18. The axle 16 interconnects the wheels 13 and the steering column 18. A steering wheel 20 attaches to the steering column 18 to transfer motion from an interior 22, or cabin of the vehicle 10 through the axle 16 to the wheels 13. The steering wheel 20 allows a driver to translate motion through the steering column 18 to the wheels 13 and provide direction as the vehicle travels. In order to change directions, and operator (not shown) of the vehicle 10 turns the steering wheel 20 either clockwise, or counterclockwise such that the wheels 13 turn to a degree proportional to the motion of the steering wheel 20. Reducing the overall weight of the steering wheel 20 provides the operator with an easier and lighter advantage when making a turn. Likewise, since the steering wheel 20 is interconnected, via the steering column 18 and the axle 16, to the wheels 13, noise vibration and harshness may be transmitted through the steering system 12 to the steering wheel 20. This noise, vibration, and harshness may be felt by the operator on the steering wheel 20 providing an uncomfortable steering experience.

As will be described in more detail below, the steering wheel 20 attaches to the steering column 18 via a steering wheel armature 24, or an armature 24. A fastener 26 may be used to interconnect the steering wheel armature 24 of the steering wheel 20 to the steering column 18. The armature 24 comprises a hub 28 a spoke 30 and a rim 32. The hub 28 is disposed in line with a center 33 of the Armature 24. The hub 28 interconnects the steering wheel 20 with the steering column 18. Stated differently, the hub 28 attaches to the steering column 18 using the fastener 26 to secure the steering wheel 20 to the steering column 18. In this way, the steering wheel 20 is fastened to the steering column 18 using the hub 28 at the center 33 of the steering system 12. The steering wheel 20 also includes the rim 32. Specifically, the rim 32 extends along an outer perimeter 38 of the steering wheel 20. The spoke 30 secures the rim 32 to the hub 28. The spoke 30 may also include a plurality of spokes 30 depending on styling and design options of the steering wheel 20.

The steering wheel 20, including the steering wheel armature 24, typically varies depending on vehicle size, type or style. For example, smaller vehicles 10 may typically include a steering wheel 20 generally smaller than a steering wheel 20 used for a larger vehicle 10. Likewise, smaller vehicles 10 may attach the rim 32 to the hub 28 using less spokes 30 than larger vehicles 10. The steering wheel 20, including the armature 24, typically define a single material such that the material properties of the steering wheel 20 are uniform throughout the steering wheel 20. Using a single material to form the steering wheel 20 may require adding static weight across the rim 32 or by forming the steering wheel 20 using a high density metal to reduce the transmission of noise, vibration, and harshness through the steering system 12. As will be described in more detail below, to account for the design variances, such as between smaller and larger vehicles described above, as well as reducing noise, vibration, and harshness through the steering system 12 without adding static weight to the rim 32, the hub 28 may define a first portion 40 and a second portion 42.

Referring to FIG. 2, a perspective view of the steering system 12, including the steering wheel 20, the armature 24 and the steering column 18 is shown. As previously described, the hub 28 includes first and second portions 40, 42. The first portion 40 of the hub 28 is welded to the second portion 42 of the hub 28. The first portion 40 of the hub 28 is attached to the spoke 30 at a first end 44 of the spoke 30. The spoke 30 is connected to the rim 32 at a second end 46 of the spoke 30. In this way, the first portion 40 of the hub 28 interconnects the rim 32 and the spoke 30 to the steering column 18. Similarly, the second portion 42 of the hub 28 interconnects the first portion 40 of the hub 28, including the spoke 30 and the rim 32 to the steering column 18. Further, as stated above, the hub 28 is attached to the steering column 18 at the center 33 of the armature 24. Therefore, the first and second portions 40, 42 are aligned and secure the steering wheel 20 to the steering column 18 at the center 33 of the armature 24. This allows the hub 28 to be a common hub 28 such that the first and second portions 40, 42 of the hub 28 may be used on a variety of vehicles 10 with differing designs and styles of the steering wheel 20.

As stated above, the first and second portions 40, 42 may be welded together. For example, the first portion 40 may be friction stir welded to the second portion 42. In at least one other embodiment, the first portion 40 may be linear friction welded to the second portion 42. In yet a further embodiment, the first portion 40 may be friction spin welded to the second portion 42. The welding process, for example friction stir, linear friction, or friction spin, depends on the design intricacy of the steering wheel 20 and the steering column 18. However, welding the first portion 40 to the second portion 42 allows for a common design of a horn system (not shown) for the vehicle 10, a common attachment and interface with a driver airbag (not shown) within the steering wheel 20, and employs a common interface between the steering wheel 20 and the steering column 18, including attachments (not shown) commonly used with the steering column 18. Therefore, the hub 28 accounts for variations between different types of vehicles 10. Allowing for commonalities for a clock spring (not shown), the horn system (not shown), and the airbag (not shown) aids to reduce overall tooling cost for the vehicle 10 and design time for the steering wheel 20, steering column 18 and steering system 12.

The first and second portions 40, 42 of the hub 28 may also be formed from different materials. For example, the first portion 40 may define a metallic alloy being different from a metallic alloy that forms the second portion 42. In this way, the first and second portions 40, 42 each define different metallic alloys. As will be described in more detail below, the rim 32 may be welded to the spoke 30, and the spoke 30 may be welded to the hub 28. More specifically, the first portion 40 of the hub 28 may be joined to the spoke 30 and the rim 32 using the same welding processes, namely friction stir welding, linear friction welding, or friction spin welding. Again, the welding process used to join the rim 32 to the spoke 30 and the spoke 30 to the first portion 40 of the hub 28 may depend on a design of the steering wheel 20. Similar to the first and second portions 40, 42, the spoke 30 may be formed from a material that is different from a material used to form the rim 32. Similarly, the spoke 30, the rim 32, and the first and second portions 40, 42 of the hub 28 may each define different metallic alloys. In at least one other embodiment, the rim 32, the spoke 30, and the first and second portions 40, 42 of the hub 28 may all define the same metallic alloy.

The type of metallic alloy used for the rim 32, the spoke 30, and the first and second portions 40, 42 of the hub 28 depends on a mass moment of inertia required for the steering wheel 20. For example, the spoke 30 and the rim 32 may be formed from a metallic alloy having a density greater than a density of the first and second portions 40, 42 of the hub 28. Likewise, the spoke 30 and the rim 32 may define a mass greater than a mass of the first and second portions 40, 42 of the hub 28. Forming the spoke 30 and the rim 32 from a metallic alloy defining a density and a mass greater than a density and a mass of the first and second portions 40, 42 of the hub 28 increases the mass moment of inertia for the steering wheel 20. Increasing the mass moment of inertia for the steering wheel 20 reduces the need to add additional static mass to the rim 32. Eliminating the addition of static mass to the rim 32 reduces the overall weight of the steering wheel 20 while accounting for noise, vibration and harshness through the steering wheel 20.

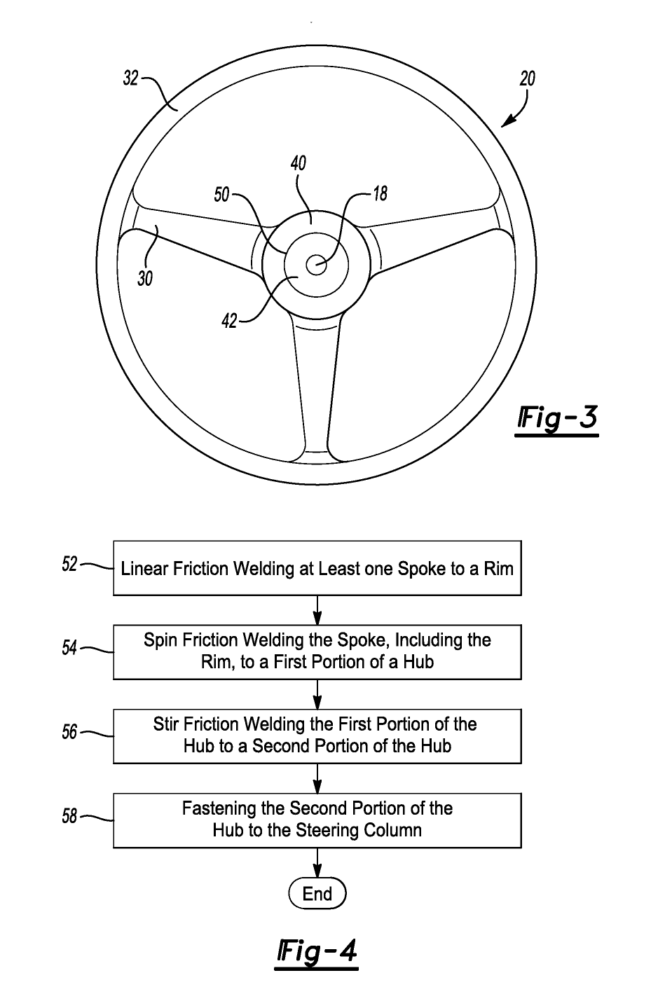

Referring to FIG. 3, a front view of the steering wheel 20 is depicted. As detailed above, the first and second portions 40, 42 of the hub 28 may be formed from different metallic alloys. Similarly, the spoke 30 and the rim 32 may also be formed from different metallic alloys. In at least one embodiment, the spoke 30, the rim 32 and the first portion 40 of the hub 28 may be formed from a metallic alloy different from a metallic alloy forming the second portion 42 of the hub 28. In at least one other embodiment, the spoke 30, the rim 32 and the second portion 42 of the hub 28 may be formed from a metallic alloy being different from a metallic alloy forming the first portion 40 of the hub 28. Likewise, the spoke 30, the rim 32, and the first and second portions 40, 42 of the hub 28 may each define different metallic alloys. Again, the selection of the metallic alloys that form the spoke 30, the rim 32, and the first and second portions 40, 42 of the hub 28 may be defined by characteristics of the vehicle 10 as well as a weight of the steering wheel 20 and the mass moment of inertia of the steering wheel 20.

For example, the rim 32 may be formed from aluminum and the spoke 30 may be formed from steel. In a similar example, the hub 28, including the first and second portions 40, 42 may be formed from steel and the rim 32 and spokes 30 may be formed from aluminum. The welding processes described above, namely friction stir welding, linear friction welding and friction spin welding allow the joining of two dissimilar metals, such as steel and aluminum. Using these welding processes to form the steering wheel 20 allows for the adjoining of more selective metals based on weight and density, as described above. In another example, the first portion 40 of the hub 28 may be formed from aluminum while the second portion 42 of the hub 28 may be formed from steel. Using two different metallic alloys, such as steel and aluminum, to form the first and second portions 40, 42 of the hub 28 provides more design options to form the steering wheel 20 and control over the mass moment of inertia and weight of the steering wheel 20.

As shown in FIG. 3, the first portion 40 of the hub 28 may be attached to the second portion 42 of the hub 28 at a weld line 50. The weld line 50 is indicative of a location that connects the first portion 40 to the second portion 42. Preferably, the weld line 50 may be indicative of a stir friction welding process or a spin friction welding process used to attach the first portion 40 to the second portion 42 of the hub 28. Again, using varying welding processes to attach the spoke 30 to the rim 32 and the spoke 30 to the first portion 40 of the hub 28, and the first portion 40 of the hub 28 to the second portion 42 of the hub 28 provides commonality across design variations for differing vehicles 10 and allows the hub 28 to be a common hub 28 that is used regardless of the vehicle type, size and model.

While shown in FIG. 3 as having a substantially circular shape, the steering wheel 20, including the first and second portions 40, 42 of the hub may also be substantially square. The shape of the steering wheel 20, and specifically the first and second portions 40, 42 of the hub 28 may influence the welding process used to join the first and second portion 40, 42. By way of example, if the first and second portion 40, 42 define a substantially circular shape, spin friction welding may be used to join the first and second portion 40, 42. Likewise, if the first and second portion 40, 42 define a substantially rectangular shape, stir friction welding may be used to join the first and second portions 40, 42.

FIG. 4 depicts a flowchart for a method according to the present disclosure. While shown sequentially, the steps of the method for manufacturing and interconnecting the steering wheel armature 24 to the steering column 18 may be performed simultaneously, or in any order that allows different welding processes to join two dissimilar metals. Further, as shown in FIG. 4, the method describes one embodiment for forming the steering wheel 20 and interconnecting the steering wheel armature 24 to the steering column 18. In other embodiments, other welding processes, as described above, may be used to adjoin the rim 32, the spoke 30 and the first and second portions 40, 42 of the hub 28 to the steering column 18. At 52, linear friction welding is used to join at the least one spoke 30 to the rim 32. Again, as stated above, the steering wheel 20 may include a plurality of spokes 30 or at least two spokes 30. The number of spokes 30 used with the steering wheel 20 may depend on vehicle size and design intricacy. At 54, spin friction welding is used to join the spoke 30, including the rim 32, to the first portion 40 of the hub 28. At 56, stir friction welding is used to join the first portion 40 of the hub 28, including the spoke 30 in the rim 32, to the second portion 42 of the hub 28.

When the first portion 40 of the hub 28, including the rim 32 and the spoke 30, is joined to the second portion 42 of the hub 28, the steering wheel 20 is formed and ready for attachment to the steering column 18. Again, in at least one other embodiment, spin friction welding may be used to join the first and second portions 40, 42 of the hub 28. Once formed, the steering wheel 20, including the rim 32, the spoke 30 and the first and second portions 40, 42 of the hub 28 are fastened to the steering column 18 at 58 along the center 33. Fastening the steering wheel 20 to the steering column 18 at 58 may be accomplished using traditional fasteners (not shown). At 58, the steering wheel 20 may be fastened to the steering column 18 using any fastening method common four interconnecting the steering wheel 20 to the steering column 18. As stated previously, the steps of the method are merely shown as exemplary and may be performed in any order.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A steering wheel armature comprising:
a hub having a first portion, and a second portion being attached to a steering column;
a spoke attached to the first portion of the hub via friction welding; and
a rim friction welded to the spoke to interconnect the rim and the first portion of the hub, wherein the first portion is stir friction welded to the second portion such that the rim is attached to the steering column.

2. The steering wheel armature of claim 1, wherein the spoke is attached to the first portion of the hub via linear friction welding.

3. The steering wheel armature of claim 1, wherein the rim is stir friction welded to the spoke.

4. The steering wheel armature of claim 1, wherein the rim is aluminum and the spoke is steel.

5. The steering wheel armature of claim 1, wherein the hub is steel and the rim is aluminum.

6. A vehicle comprising:
a steering column; and
a steering wheel armature including,
a hub having first and second portions, the second portion being attached via a fastener to the steering column,
a spoke friction welded to the first portion of the hub, and
a rim friction welded to the spoke interconnecting the rim with the first portion of the hub, wherein the first portion of the hub is spin friction welded to the second portion to connect the steering wheel armature to the steering column.

7. The vehicle of claim 6, wherein the spoke and the rim define a density greater than a density of the first and second portions of the hub.

8. The vehicle of claim 6, wherein the spoke includes at least two spokes.

9. The vehicle of claim 6, wherein the spoke is friction welded to the first portion of the hub via a stir friction weld.

10. The vehicle of claim 6, wherein the spoke and rim define a mass greater than a mass of the first and second portions of the hub.

11. The vehicle of claim 6, wherein the first and second portions of the hub define different metallic alloys.

12. A method for interconnecting a steering wheel armature to a steering column comprising:
linear friction welding at least one spoke to a rim;
spin friction welding the at least one spoke, including the rim, to a first portion of a hub;
stir friction welding the first portion of the hub to a second portion of the hub; and
fastening the second portion of the hub to the steering column.

13. The method of claim 12, wherein the spoke and the rim define a density greater than a density of the first and second portions of the hub.

14. The method of claim 12, wherein the spoke and rim define a mass greater than a mass of the first and second portions of the hub.

15. The method of claim 12, wherein the first and second portions of the hub define different metallic alloys.

16. The method of claim 12, wherein the spoke and rim define different metallic alloys than the first and second portions of the hub.

17. The method of claim 12, wherein the spoke defines a first metallic alloy and the rim defines a second metallic alloy.
